(19) United States
(12) Patent Application Publication
(10) Pub. No.: US 2002/0150708 A1
(43) Pub. Date: Oct. 17, 2002

(54) Bag

(75) Inventors: Zoe Dyter, Newcastle upon Tyne (GB); Nigel Patrick Somerville Roberts, Newcastle upon Tyne (GB); David William York, Newcastle upon Tyne (GB); Graeme Duncan Cruickshank, Newcastle upon Tyne (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 09/923,012

(22) Filed: Aug. 3, 2001

(30) Foreign Application Priority Data
May 8, 2000 (GB) 0019159.3

(51) Int. Cl. B32B 1/02

(52) U.S. Cl. 428/35.4

(57) ABSTRACT

The present invention relates to a laundry bag made of an alkaline-soluble material which contains a detergent composition. Said laundry bag is suitable for use in an automatic washing machine.

### FIELD OF THE INVENTION

The present invention relates to a bag, more particularly to a laundry bag for use in cleaning soiled laundry. In particular, the present invention relates to a laundry bag made of an alkaline-soluble material, and which contains a detergent composition.

### BACKGROUND TO THE INVENTION

Current laundry wash products consist, and are used, in a wide variety of forms. These forms traditionally include detergent granules and liquids. These products are typically used in laundry washing practices which involve sorting out and dividing soiled laundry into more than one wash load, transporting a wash load to a washing machine and inserting said wash load into said washing machine. Detergents then need to be added to said washing machine. This practice can be time consuming and tiresome for the consumer. In addition, during this laundry washing practice, the consumer comes into close proximity to the soiled laundry and detergent, on numerous occasions.

In the past, attempts have been made to improve these traditional product forms, these attempts have led to the development of detergent tablets. However, there is still a need to improve this time consuming laundry washing practice, and to minimise the amount of contact which occurs between the consumer and the soiled laundry and detergent, during the laundering process.

The present invention provides a laundry bag, which improves the efficiency of current washing processes, decreases the duration of typical laundry washing processes and minimises the amount of contact between the consumer and the soiled laundry and detergent. The inventors have found that by using a laundry bag made of an alkaline-soluble material, which contains a detergent composition, the above mentioned problems are overcome.

### SUMMARY OF THE INVENTION

In a first embodiment of the present invention, a laundry bag made of an alkaline-soluble material is provided, said laundry bag contains a detergent composition.

In a second embodiment of the present invention, the use of a laundry bag made of an alkaline-soluble material, which contains a detergent composition, in a laundering process, is provided.

In a third embodiment of the present invention, a process for preparing a laundry bag made of an alkaline-soluble material, and which contains a detergent composition is provided, which comprises the steps of adding a detergent composition, or part thereof, to a pouch of alkaline-soluble material, and adding said pouch to a laundry bag made of alkaline-soluble material.

### DETAILED DESCRIPTION OF THE INVENTION

### Laundry Bag

The laundry bag, herein referred to as “bag”, is made of an alkaline-soluble material. The term “alkaline soluble” means substantially soluble in an alkaline solution of pH 12, typically this is determined using the following method; 0.1 g of the material to be tested, which is in one whole piece that is not cut into smaller pieces, and is not folded or crumpled, is added to 200 ml of alkaline solution at a pH of 12, and at a temperature of 40° C. Said solution is made exclusively by adding sodium hydroxide to deionised water. Said solution contains no other deliberately added contaminants. After ten seconds, start moderately stirring the solution, for example using a IKA labortechnik magnetic stirrer rotating at 50 rpm. Stir the solution for a further 50 seconds, so that the total time the material being tested is in contact with the solution is exactly 1 minute. Keep the solution at 40° C. during this stirring step. Pass the solution through a 250 micrometer sieve to collect any undissolved content. Dry this undissolved content in an oven at 40° C. until constant weight. Weigh this dried undissolved content and calculate the % by weight of this undissolved content. Repeat this method two times and take the average result.

Material having less than 20% by weight, preferably less than 15% by weight, more preferably less than 10% by weight, even more preferably less than 5% by weight, even more preferably less than 2% by weight, most preferably less than 0.5% by weight, undissolved content as determined by the above method, is within the meaning of the term “alkaline soluble” for the purpose of the present invention. Said alkaline-soluble material is described in more detail hereinafter.

The bag herein contains a detergent composition. Said detergent composition is described in more detail hereinafter.

The bag herein is a laundry bag. A laundry bag is a bag which is of a size suitable to hold at least one item of laundry. The size of the bag herein is dependant on its application. For example, the inner volume of the bag herein can be large, for example of a size from 2m³ or from 3m³, to 6m³ or to 7m³, which can hold large washing loads, for example washing loads up to 20 kg, for example, for use by a family household, or even for use by a hotel or restaurant. The inner volume of the bag herein can also be small, for example of a size from 0.01 m³ or from 0.1 m³, to 2m³ or to 3m³ suitable for holding washing loads consisting of several small to medium sized laundry articles, for example washing loads from 0.01 kg or from 0.1 kg, to 5kg, or to 10 kg, for example, for personal use to hold a gym kit or football kit. The inner volume of the bag herein is preferably from 0.01 m³ to 6 m³.

Preferably, the bag herein as a whole is alkaline-soluble. The term “alkaline soluble” is defined hereinbefore.

The bag herein may also comprise a transparent viewing patch, or the bag as a whole may be transparent so that the consumer can see what is contained in said bag. For example, the bag may be made of an alkaline-soluble material, or part thereof, which is transparent. Said alkaline-soluble material, or part thereof, may be in the form of a film which is transparent.

The bag herein may also be different colors or contain different markings or patterns on the surface. This could be used to indicate to the consumer the type of detergent composition, or the amount of detergent composition, that is contained in said bag. Said patterns are preferably made from an alkaline-soluble dye. It is highly preferably that said dye is not fabric substantive.

The bag herein may also contain a means of indicating to the consumer that the bag is full or the optimal amount, volume or weight of washing load is present in said bag. This could be by markings on the bag indicating the optimal level said bag should be filled with wash load. Said markings are preferably alkaline-soluble.

The bag herein preferably has at least one opening. It is highly preferred that at least one opening of the bag gives access to the inner volume space of said bag. Said opening can be closed, for example, by a closing means. Said closing means are described in more detail hereinafter.

The inner volume space of the bag herein can be separated into more than one compartment. These compartments are preferably separated by a barrier means. Preferably said barrier means is alkaline soluble, more preferably said barrier means is made of an alkaline-soluble material, this alkaline-soluble material may be the alkaline soluble material of which the bag herein is made of, or may be a different piece of alkaline-soluble material. This allows the consumer to use different compartments to sort a washing load depending on consumer preference, for example by fabric type, fabric color, or soil/stain type or severity.

The inner volume space of the bag herein can be closed, such that said inner volume space is separated from the outside. For example, by closing means such as a tuck, tie, flap, fold, zip, button, draw string or combination thereof. Said closing means is preferably alkaline soluble, preferably said closing means is made of an alkaline-soluble material, this alkaline-soluble material may be the alkaline soluble material of which the bag herein is made of, or may be a different piece of alkaline-soluble material. Said closing means is preferably non-permanent and the bag herein can be closed and re-opened numerous times. Alternatively, said closing means can be permanent, so that the bag herein can only be closed once.

Upon closing the bag, any further contact between the laundry items contained therein and the consumer is prevented, reduced or minimised. Furthermore, since the bag herein contains a detergent composition, there is no need for the consumer to re-open said bag to add thereto a detergent composition. Since the detergent composition is contained within the bag herein, there is also no need for additional detergent composition to be added to the washing load during the washing process. The bag herein provides a convenient means of washing fabric, especially during conventional washing practices such as, for example, using an automatic washing machine.

Preferably, the bag herein comprises a dispensing unit which contains or comprises the detergent composition, or part thereof, of the bag herein. Preferably, the detergent composition, or part thereof, is contained in a dispensing unit which is sealed such that the detergent composition, or part thereof, is separated from the rest of the inner volume space of the bag which is intended to contain soiled laundry. By “separated” it is preferably meant prevented from contacting or entering.

Said dispensing unit is preferably made of an alkaline-soluble material, this alkaline-soluble material may be the alkaline soluble material of which the bag herein is made of, or may be a different piece of alkaline-soluble material. Preferably, the dispensing unit as a whole is alkaline soluble.

The dispensing unit may be an integral member of said bag, this is especially preferred if said dispensing unit is made of the material which the bag herein is made from. Alternatively, the dispensing unit may not be an integral member of the bag herein, although even if said dispensing unit is not an integral member of said bag, said dispensing unit may still be made of alkaline-soluble -soluble material of the same type as that from which said bag is made of.

The Inventors have found that the flexibility of said bag, is further improved when said detergent composition, or part thereof, is contained in a dispensing unit which is not an integral member of said bag. If said dispensing unit is not an integral member of the bag, the consumer can remove, replace, exchange or add numerous dispensing units to or from said bag. This allows the consumer to modify said laundry bag according to their own preference, for example depending on their likes and dislikes, and on the amount or severity of soiled laundry to be deposited in said bag.

Said dispensing unit can be designed such that when the bag herein is closed, or in response to some other action directed on or toward the bag herein, said dispensing unit is ruptured or burst so that said detergent composition, or part thereof, is released from said dispensing unit. Also, it may be preferred that more than one dispensing unit containing or comprising the detergent composition, or part thereof, of the bag, are contained in said bag. The preferred number of dispensing units contained in the bag herein is determined by the size of the wash load to be washed and the severity of the soiling of said wash load. Typically, from one to five dispensing units can be contained in the bag herein.

Different dispensing units may contain different constituent ingredients, for example incompatible detergent ingredients, of the detergent composition of the bag herein. Therefore, the use of more than one dispensing unit in the bag herein provides a means of separating incompatible detergent ingredients from each other.

A preferred dispensing unit is a cell, pouch, pocket, fold, packet, sheet or combination thereof. Preferably the dispensing unit is a pouch of alkaline-soluble material, and the detergent composition of the bag herein is contained in said pouch of alkaline-soluble material. The pouch of alkaline-soluble material is contained in said bag.

The bag herein can be designed such that; said bag, or part thereof, for example a single compartment of a multi-compartment bag, one or more dispensing units, or a combination thereof, will open, rupture, dissolve, disintegrate or a combination thereof, under specific conditions, for example temperature, pH, ionic strength or mechanical agitation. This provides a means of sequentially releasing detergent components and/or laundry articles from the bag herein which could be used to optimise the washing process.

For example, having a fabric softening agent contained in a dispensing unit, said dispensing unit remains intact during the washing stages of the washing cycle and only disintegrates, dissolves or ruptures during the rinse stage of the washing cycle. This could be in response to a specific condition, for example, mechanical agitation of the spin stage in an automatic washing machine, or the decrease in pH or ionic strength, of the wash solution due to the influx of water into the drum of an automatic washing machine during the rinse stage of the washing cycle. Therefore, in this manner, said softening agent is released from said dispensing device during the rinse stage of the washing cycle.

Said bag can be made by any process which converts an alkaline-soluble material, typically in the form of a film, a non-woven material, or a laminate of a film and a non-woven material, into a structure suitable for use as a laundry bag. The material can be shaped by any method known in the art, for example by cutting with a knife.

The bag can be made from one or more pieces of alkaline-soluble material. Preferably, the material is shaped into a bag like structure, by sealing pieces of alkaline-soluble material together, for example by heat sealing, pressure sealing, or by gluing means. A preferred glue for use herein is an alkaline soluble glue, more preferred is a glue which comprises a polyvinyl alcohol. Typically, the process of sealing said bag results in the formation of a seam. Said seam can be present on the rear face of the bag, the side of the bag, the front face of the bag , the bottom of the bag, the top of the bag, or any combination thereof.

The detergent composition, or part thereof, can be included in the bag herein by being incorporated in the alkaline-material of the bag. The detergent composition, or part thereof, may also be sprayed onto a sheet or other component of the bag herein, preferably the alkaline -soluble material of the bag. Preferably, the detergent composition of the bag herein is contained in the bag herein such that said detergent composition is separately from the inner volume space which is intended to contain soiled laundry which is deposited therein. This may be achieved by sealing said detergent composition into the bag so that said detergent composition is separated by at least one barrier means from said inner volume space which is intended to contain soiled laundry which is deposited therein. Said barrier means is preferably made of an alkaline soluble material, this alkaline soluble material may be the alkaline soluble material from which the bag herein is made of, or it may be a different piece of alkaline material from the alkaline material from which the bag herein is made of.

Preferably, the detergent composition is added to a pouch of alkaline-soluble material, said pouch of alkaline-soluble material is added in a laundry bag made of alkaline-soluble material, to obtain a bag for use herein. A preferred method of preparing a bag in accord with the present invention comprises the following steps; adding a detergent composition, or part thereof, to a pouch of alkaline-soluble material; and adding said pouch to a laundry bag made of alkaline-soluble material.

### Alkaline-Soluble Material

The alkaline-soluble material is substantially soluble in an alkaline solution. The term “alkaline soluble” is defined hereinbefore.

When soiled laundry, which is damp, is deposited in a laundry bag made of said alkaline-soluble material, said bag may start to dissolve, loose its structural integrity and cannot adequately be used to hold or transport said damp soiled laundry. This problem is overcome by selecting an alkaline-soluble material which is substantially water-insoluble at 20° C., and thus does not dissolve when damp soiled laundry is deposited in said bag. Therefore, the alkaline-soluble material is preferably substantially water insoluble at 20° C. The term “water insoluble” means insoluble in deionised water at a pH of 6 and at a temperature of 20° C., typically this is determined using the following method;

0.1 g of the material to be tested, which is in one whole piece that is not cut into smaller pieces, and is not folded or crumpled, is added to 200 ml deionised water at a pH of 6, and at a temperature of 20° C. Said deionised water contains no other deliberately added contaminants. After ten seconds, start moderately stirring the deionised water, for example using a IKA labortechnik magnetic stirrer rotating at 50 rpm. Stir the deionised water for a further 50 seconds, so that the total time the material being tested is in contact with the solution is exactly 1 minute. Keep the deionised water at 20° C. during this stirring step. Pass the deionised water through a 250 micrometer sieve to collect any undissolved content. Dry this undissolved content in an oven at 40° C. until constant weight. Weigh this dried undissolved content and calculate the % by weight of this undissolved content. Repeat this method two times and take the average result.

Material having at least 50% by weight, preferably at least 60% by weight, more preferably at least 70% by weight, even more preferably at least 80% by weight, even more preferably at least 90% by weight, most preferably at least 99.5% by weight, undissolved content as determined by the above method, is within the meaning of the term “water-insoluble” for the purpose of the present invention.

The Inventors have found that if an alkaline source, such as a detergent composition, is in contact with an alkaline-soluble material for a prolonged period of time, for example for at least one day, or three days, or a week, or a month, or even several months, said alkaline soluble material may become alkaline insoluble due to the interaction of said alkaline soluble material with said alkaline source. It is preferred that the alkaline-soluble material, after prolonged contact with an alkaline source, remains soluble in an alkaline solution.

The alkaline-soluble material is preferably a non-woven material, a film, a laminate of a film and a non-woven, or a combination thereof. Preferably, the alkaline-soluble material is a non-woven material.

The alkaline-soluble material preferably comprises a polyvinyl alcohol polymer, a co-polymer of a polyvinyl alcohol, a copolymer of a styrene and acrylic acid, hydroxypropyl methyl cellulose (HPMC), or a combination thereof. Preferably, the alkaline-soluble material comprises a polyvinyl alcohol polymer, a co-polymer of a polyvinyl alcohol, or a combination thereof.

Alkaline-soluble material suitable for use herein which comprises a polyvinyl alcohol polymer, a co-polymer of a polyvinyl alcohol, or a combination thereof, preferably has an average degree of hydrolysis of any range from 70%, or from 75%, or from 80%, or from 85%, or from 90%, or from 95%, and to 100%, or to 99%, or to 98%, or to 95%, or to 90%, or to 85%, or to 80%. Preferably, the alkaline-soluble material has an average degree of hydrolysis of at least 80%, more preferably of from 80% to 90%, or preferably from 95% to 100%.

The alkaline-soluble material preferably comprises a plasticiser. Said plasticiser preferably comprises a member selected from the group consisting of glycol, glycerine, alcohol amine, alkoxylated phosphate, polyol, and combinations thereof. More preferably said plasticiser comprises a member selected from the group consisting of mono-ethylene glycol, di-ethylene glycol, tri-ethylene glycol, polyethylene glycol having a weight average molecular weight of from 155 to 400, glycerine, trimethylol propane, neopentyl glycol, triethanolamine, ethoxylated phosphates, and combinations thereof.

Preferably, said plasticiser comprises more than one type of plasticiser, said plasticiser may comprise at least two types of plasticiser. Preferably, the weight ratio of the first type of plasticiser to the second type of plasticiser is from 1:1 to 3:1, more preferably from 1.5:1 to 2.5:1.

The alkaline-soluble material preferably comprises (by weight of said alkaline-soluble material) from 1%, or from 5%, or from 10%, or from 20%, or from 25%, and preferably to 60%, or to 50%, or to 40% plasticiser.

The alkaline-soluble material may comprise the detergent composition, or part thereof, which is contained by said bag herein. The detergent composition, or part thereof, may be incorporated into the alkaline-soluble material of the bag, or may be sprayed onto the alkaline-soluble material of the bag. This is a convenient method of containing the detergent composition in said bag.

If the detergent composition, or part thereof, is sprayed onto said alkaline-soluble material, preferably the detergent composition is absorbed by said alkaline-soluble material. In addition, preferably the detergent composition, or part thereof, that is sprayed onto said alkaline-soluble material is present on the inside surface of the bag herein. This minimises, reduces or prevents the amount of contact between said detergent composition, or part thereof, and the consumer.

If said detergent composition, or part thereof, is comprised by said alkaline-soluble material, then the release of said detergent composition, or part thereof, from said alkaline-soluble material is determined by the rate at which said alkaline-soluble material dissolves during the washing cycle.

Different areas of said alkaline-soluble material may have different solubility properties, such as rate of solubility, so that said different areas of said alkaline-soluble material dissolve at different stages of the washing cycle. These different areas of the alkaline-soluble material may comprise different parts of said detergent composition, and thus these different parts of the detergent composition will by released from these areas of alkaline-soluble material at different stages of the washing cycle. Thus, in this manner, a means of sequentially releasing detergent ingredients during the washing cycle is provided.

It may be preferred that incompatible parts of said detergent composition can be comprised by different areas of said alkaline-soluble material and, thus, separated from each other.

The alkaline-soluble material may comprise a surfactant, a starch, a modified starch, or a combination thereof. It may be preferred that only part of the material herein comprises a surfactant, a starch, a modified starch, or a combination thereof.

Preferred alkaline-soluble materials for use herein have similar properties to material known under the trade name as LXP 4088 38μp supplied by Chris Craft.

Preferred alkaline-soluble material which comprises polyvinyl alcohol and is in the form of a film are films known under the trade name as M8630 38μ supplied by Chris Craft, LXP4087 38μ supplied by Chris Craft, LXP4088 38μ supplied by Chris Craft, LXP 4107 38μ supplied by Chris Craft, VF-HP film supplied by Kuraray, and film 101 supplied by Belland.

Preferred alkaline-soluble material which comprises polyvinyl alcohol and is in the form of a non-woven material are materials known under the trade name as HEN-30 gsm supplied by BFF, K2 40 gsm supplied by Cast Film Technology, and WN-2 35 gsm supplied by Kuraray.

Preferred alkaline-soluble material which comprises polyvinyl alcohol and is in the form of a laminate of a film and a non-woven material is laminate material known under the trade name as BT2102 supplied by Kuraray, and WN-2 laminate supplied by Kuraray.

### Detergent Composition

The bag herein contains a detergent composition. The detergent composition, or part thereof, for use herein may be in the form of a solid (such as a granular composition, for example, tablet or powder), a liquid, a paste, a gel, or a combination thereof.

The detergent composition, or part thereof, may be comprised by the alkaline-soluble material of the bag herein. The detergent composition, or part thereof, may be sprayed onto, and may be absorbed by, the alkaline-soluble material of the bag herein. The detergent composition, or part thereof, may be contained in a pouch of alkaline-soluble material. The detergent composition, or part thereof, may be contained by said bag herein in the form of a detergent sheet.

The detergent composition of the bag is preferably contained in said bag in at least two parts. One or more parts of the detergent composition are contained separately in the bag from one or more other parts of the detergent composition.

For example, different parts of the detergent composition may be contained in different dispensing units. Different parts of the detergent composition may be comprised by different areas of the alkaline-soluble material of the bag, as described hereinbefore. This allows incompatible detergent ingredients to be separated form each other within the bag herein. It may be preferred that, if present, the bleaching agent is contained separately within the bag from the enzyme(s). It may also be preferred that, if present, the odour controlling agent is contained separately with the bag from odour releasing detergent ingredients such as amine containing compounds, surfactants, especially cationic surfactants, more especially amine containing cationic surfactants, or combinations thereof. This can also allow different parts of the detergent composition to be sequentially released into the wash liquor during the washing cycle, as described hereinbefore.

Said detergent composition is preferably contained in the bag herein in an amount sufficient for washing the wash load deposited in the bag herein. Alternatively, there is enough detergent composition contained in said bag to wash a full washing load. This allows the consumer to add more soiled laundry, which is in addition to the laundry contained in the bag, to a washing machine which contains a laundry bag in accord with the present invention, without having to add more detergent to said washing machine.

The detergent composition preferably comprises a member selected from the group consisting of odour control agent, surfactant, chelating agent, building agent, enzyme, bleaching agent, fabric softener, fabric conditioner, effervescence system, brightener, photo-bleach, suds suppressing agent, perfume and combinations thereof.

Preferably the detergent composition of the bag comprises at least 5% surfactant and at least 5% building agent. Preferably the detergent composition comprises (by weight) at least 0.1%, or preferably at least 0.2%, or preferably 0.4%, or more preferably at least 0.8% perfume. If said detergent composition comprises an odour controlling agent, then it may be preferred that said detergent composition comprises low amounts of perfume such as from 0.1% by weight or from 0.2% by weight perfume. Alternatively, if said detergent composition does not comprise an odour controlling agent, then it may be preferred that said detergent composition comprises high amounts of perfume such as from 0.4% by weight or from 0.8% by weight perfume. The term “odour controlling agent” is described in more detail hereinafter.

Preferred detergent ingredients of the composition of the bag are described in more detail hereinafter.

### Odour Controlling Agent

When soiled laundry is added to said bag, an odour can develop which gives a negative impression to the consumer and prevents or dissuades the consumer from leaving soiled laundry in said bag for the length of time required to fill said bag to the optimal level. In such circumstances, the consumer does not wait for said bag to be full and instead uses a half full laundry bag during the washing process. This results in an inefficient consumption of laundry bags.

The inventors have found that this inefficient consumption can be overcome by providing a bag which contains a detergent composition which comprises an odour controlling agent.

Therefore, the detergent composition for use herein preferably comprises an odour controlling agent. The detergent composition herein preferably comprises from 1%, or preferably from 2%, or from 5%, or from 7%, or from 10%, or from 12%, or from 15%, or from 17%, or from 20% odour controlling agent, and preferably to 50%, or to 40%, or to 30% odour controlling agent.

Said odour controlling agent is preferably a member selected from the group consisting of cyclodextrin, ultra wide pore zeolite or derivative thereof, metallic odour control salts, anti-microbial agent, activated carbon, potassium permanganate, and combinations thereof.

Preferably, said cyclodextrin may comprise an unsubstituted cyclodextrin comprising from six to twelve glucose units. The term “unsubstituted” means that the cavities within said cyclodextrin are substantially empty, preferably completely empty, in order to allow said cyclodextrin to absorb various odour molecules from soiled laundry that is deposited in said bag herein.

Preferably, said cyclodextrin has a primary particle size of less than 12 micrometers, preferably less than 10 micrometers, preferably less than 5 micrometers. This primary particle size refers to the largest dimension of the cyclodextrin primary particle. Cyclodextrins having this small primary particle size have a higher surface area per weight of cyclodextrin and, thus, have a greater capacity of absorbing odour.

Preferred cyclodextrins are alpha-cyclodextrin and derivatives thereof, gamma-cyclodextrin and derivatives thereof, beta-cyclodextrin derivatives, and combinations thereof. Suitable cyclodextrin derivatives for use herein include hydroxypropyl alpha-cyclodextrin, methylated alpha-cyclodextrin, methylated beta-cyclodextrin, hydroxyethyl beta-cyclodextrin and hydroxypropyl beta-cyclodextrin. Cyclodextrins and derivatives thereof suitable for use herein are described in U.S. Pat. No. 3,426,011, U.S. Pat. No. 3,453,257, U.S. Pat. No. 3,453,258, U.S. Pat. No. 3,453,259, U.S. Pat. No. 3,453,260, U.S. Pat. No. 3,459,731, U.S. Pat. No. 3,553,191, U.S. Pat. No. 3,565,887, U.S. Pat. No. 4,535,152, U.S. Pat. No. 4,616,008, U.S. Pat. No. 4,678,598, U.S. Pat. No. 4,638,058 and U.S. Pat. No. 4,746,734. Preferred cyclodextrins for use herein are described in more detail in U.S. Pat. No. 5,429,628.

Said odour controlling agent may comprise ultra wide pore zeolite or derivative thereof. Zeolite A, X and Y, which are known building agents in detergent compositions, are not within the meaning of the term “ultra wide pore zeolites” for the purpose of the present invention. Although it may be preferred that the detergent composition of the bag herein comprises zeolite A, X, Y or a combination thereof. If zeolite A, X, Y or a combination thereof is present in the detergent composition of the bag, then it may be preferred that said detergent composition further comprises an odour controlling agent, for example an ultra wide pore zeolite or derivative thereof.

Ultra wide pore zeolites or derivatives thereof preferably have a pore diameter of at least 13 angstroms, more preferably at least 20 angstroms, even more preferably at least 30 angstroms, or even 50 angstroms, most preferably from 30 to 100 angstroms. The pore diameter can be determined by any suitable method, for example by transmission electron microscopy (TEM), x-ray diffraction or argon physisorption. TEM is the preferred technique. These ultra wide pore zeolites or derivatives thereof, preferably have a surface area of at least 300 m² g⁻¹, more preferably at least 400 m² g⁻¹, most preferably at least 500 m² g⁻¹.

Suitable ultra wide pore zeolite derivatives are ultra wide pore zeolite alumino-derivatives. Preferred ultra wide pore zeolite alumino-derivatives are aluminophosphates, silicoaluminophosphates, metalloaluminophosphates and metallosilicoaluminophosphates, wherein ‘metallo’ represents an additional metallic element such as Mg, Ti, Mn, Co, Fe, Ga or Zn.

Other suitable ultra wide pore zeolite derivatives are ultra wide pore zeolite phosphate-derivatives. Preferred ultra wide pore zeolite phosphate-derivatives are AlPO4-5, AlPO4-8, SAPO-5, SAPO-37, VPI-5, Cloverite (an 18-membered ring gallophosphate), and JDF-20.

Other preferred ultra wide pore zeolite derivatives are the liquid crystal template-synthesised M41S range of compounds described in U.S. Pat. No. 5,102,643, U.S. Pat. No. 5,250,282, U.S. Pat. No. 5,264,203, U.S. Pat. No. 5,145,816, U.S. Pat. No. 5,098,684, U.S. Pat. No. 5,378,440, U.S. Pat. No. 5,098,684, U.S. Pat. No. 5,108,725 and U.S. Pat. No. 5,057,296. These M41S range of compounds exhibit, after calcination, an x-ray diffraction pattern with at least one peak at a d-spacing greater than 18 angstroms with a relative intensity of 100 and a benzene adsorption capacity of greater than 15 grams benzene per 100 grams of anhydrous crystal at 50 torr and 25° C.

Highly preferred M41S compounds are inorganic, porous, crystalline material having, after calcination, a hexagonal arrangement of uniformly-sized pores having a pore diameter of at least 13 angstroms and exhibiting a hexagonal electron diffraction pattern that can be indexed with a d100 value greater than 18 angstroms. Such materials have been given the designation MCM-41 and are described in more detail in U.S. Pat. No. 5,378,440.

Said odour controlling agent may comprise a metallic odour control salt. Said metallic odour-control salts preferably comprise zinc salt, copper salt or mixtures thereof. Said metallic odour control salt preferably comprises a member selected from the group consisting of zinc chloride, zinc gluconate, zinc lactate, zinc maleate, zinc salicylate, zinc sulfate, copper chloride, copper gluconate and combinations thereof. Said metallic odour-controlling salt, especially zinc salts, may be an anti-microbial agent. Zinc salts which are metallic odour controlling salts that have anti-microbial properties, are described hereinafter.

Said odour controlling agent may comprise an anti-microbial agent. Said anti-microbial agent has anti-microbial properties such as anti-bacterial properties, anti-fungal properties or combinations thereof.

Preferred anti-microbial agents are selected from the group consisting of zinc phenolsulfonate, zinc oxide, triclosan, zinc ricinoleate, zinc undecylenate, and combinations hereof. A preferred anti-microbial compound for use herein is known under the trade name as Zelec AM supplied by Du Pont, and Irgasan DP-300 supplied by Ciba Geigy. Other anti-microbial agents suitable for use herein are described in more detail on page 10 of the 1994 edition of the “Cosmetic Bench Reference”.

The detergent composition of the bag is preferably contained separately in said bag in at least two parts, wherein the first part of said detergent composition comprises (by weight of said part) at least 60%, more preferably at least 70%, more preferably at least 80%, more preferably at least 90%, more preferably at least 95%, more preferably at least 99% odour control agent. It is also preferred that said first part of said detergent composition comprises (by weight) at least 80%, more preferably at least 85%, more preferably at least 90%, more preferably at least 95%, most preferably at least 99% of the total odour controlling agent of said detergent composition.

For example a first part of the detergent composition comprising (by weight of said part) at least 60% odour control agent, may be comprised by the alkaline-soluble material of the bag, for example by spraying said first detergent part onto the alkaline-soluble material of the bag, or incorporating said first detergent part into said alkaline-soluble material of the bag. A second part of the detergent composition, which is preferably the rest of the detergent composition, may be contained separately in said bag separately from the first part of the detergent composition, for example by being contained in a pouch of alkaline-soluble material.

This is to prevent the odour control agent of the detergent composition primarily controlling the odour emanating from the rest of the detergent composition, instead of primarily controlling the odour emanating from the soiled laundry deposited in the bag herein.

### Alkoxylated Compound

There is a tendency for a laundry bag made of an alkaline-soluble material and containing a detergent composition to reduce the clay stain removal performance of said detergent composition. This is especially true when said alkaline-soluble material comprises a polyvinyl alcohol polymer or a co-polymer of a polyvinyl alcohol.

The Inventors have solved this problem by including in the detergent composition which is contained in said bag, an alkoxylated compound having an average degree of alkoxylation of at least 25, preferably at least 50. When said detergent composition comprises said alkoxylated compound, the clay stain removal performance of said detergent composition is improved.

Therefore, said detergent composition preferably comprises an alkoxylated compound. Said alkoxylated compound may be a detergent active compound described hereinafter, such as a surfactant.

The composition comprises an alkoxylated compound, said alkoxylated compound preferably has an average alkoxylation degree of at least 25, or preferably at least 50, or preferably at least 60, or preferably at least 70, or preferably at least 80, or preferably at least 90, or preferably at least 100. Preferably the alkoxy groups are present in one long chain.

Preferably, the alkoxylated compound comprises a hydrocarbon group comprising from 6 to 24, preferably from 8 to 22, more preferably from 10 to 20, more preferably from 12 to 18 carbon atoms, preferably comprising a hydrocarbon chain of an average chain length of from 6 to 24, preferably from 8 to 22, more preferably from 10 to 20, more preferably from 12 to 18 carbon atoms. The hydrocarbon chain may be linear or branched and includes all derivative forms attainable by 6 to 24 carbon atoms in any conformation. These carbon atoms do not include the carbon atoms of the alkoxy groups.

The alkoxylated compound is preferably a nonionic compound. Preferably, the alkoxylated compound is an alcohol, an ester, a ketone, an aldehyde, an amide or a combination thereof. More preferably, the alkoxylated compound is an alcohol. Preferably, the alkoxylated compound is an ethoxylated compound. More preferably the alkoxylated compound is an ethoxylated alcohol. Most preferably, the alkoxylated compound is a tallow alcohol ethylene oxide condensate, condensed with at least 25, or preferably at least 50, or preferably at least 60, or preferably at least 70, or preferably at least 80, or preferably at least 90, or preferably at least 100 moles of ethylene oxide.

Preferably the composition for use herein comprises (by weight of said composition) from 0.001% to 25%, more preferably from 0.1% to 10%, more preferably form 0.5% to 5%, more preferably from 1% to 3% said alkoxylated compound.

### Effervescence System

The detergent composition for use herein may comprise an effervescence system. The presence of an effervescence system in said detergent composition typically increases the rate at which said detergent composition is released into the wash liquor during the wash process. A preferred effervescence system for use herein, comprises an acid source, capable of reacting with an alkali source in the presence of water to produce a gas. Said alkali source, or part thereof, and said acid source, or part thereof, may be present in said detergent composition in the same particle.

The acid source may be any organic, mineral or inorganic acid, or a derivative thereof, or a mixture thereof. Preferably the acid source component comprises an organic acid. The acid source is preferably substantially anhydrous or non-hygroscopic and the acid source is preferably water-soluble. It may be preferred that the acid source is overdried. Suitable acid sources include citric, malic, maleic, fumaric, aspartic, glutaric, tartaric succinic or adipic acid, monosodium phosphate, boric acid, or derivative thereof. Citric acid, maleic or malic acid are especially preferred.

The effervescence system preferably comprises an alkali source. Any alkali source which has the capacity to react with said acid source to produce a gas is suitable for use herein. Said gas may be any gas known in the art, including nitrogen, oxygen and carbon dioxide gas. The alkali source is preferably substantially anhydrous or non-hydroscopic. It may be preferred that the alkali source is overdried.

Preferably the gas is carbon dioxide, and therefore the alkali source is a preferably a source of carbonate, which can be any source of carbonate known in the art. In a preferred embodiment, the carbonate source is a carbonate salt. Examples of preferred carbonates are the alkaline earth and alkali metal carbonates, including sodium or potassium carbonate, bicarbonate and sesqui-carbonate and any mixtures thereof with ultra-fine calcium carbonate such as are disclosed in German Patent Application No. 2,321,001 published on Nov. 15, 1973. Alkali metal percarbonate salts are also suitable sources of carbonate species, which may be present combined with one or more other carbonate sources.

### Surfactant

The detergent composition for use herein preferably comprises surfactant. Said surfactant may comprise a member selected from the group consisting of nonionic surfactant, anionic surfactant, cationic surfactant, zwitterionic surfactant, amphoteric surfactant, and combinations thereof.

Anionic surfactants include salts (including, for example, sodium, potassium, ammonium, and substituted ammonium salts such as mono-, di- and triethanolamine salts) of the anionic sulfate, sulfonate, carboxylate and sarcosinate surfactant, preferably linear or branched alkyl benzene sulfonate, alkyl sulphates and alkyl ethoxylsulfates, isethionates, N-acyl taurates, fatty acid amides of methyl tauride, alkyl succinates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), N-acyl sarcosinates.

Highly preferred is that when anionic surfactants are present, at least one alkyl sulphate surfactant is present, preferably a branched alkyl sulphate surfactant, preferably at a level of 1% to 20% or even to 15% by weight of the component or composition.

Also, preferred nonionic surfactants are selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts.

Cationic surfactants and softening agents may also be included in the detergent composition for use herein, for example quaternary ammonium surfactants, choline ester surfactants, and softening agents.

Preferably, the detergent composition for use herein comprises (by weight) from 1% to 50% surfactant, or preferably from 5%, or from 7%, or from 10%, or from 15% surfactant, and to 45%, or to 40%, or to 35%, or to 30% surfactant. The detergent composition preferably comprises (by weight) from 1%, or preferably from 2%, or from 3% nonionic surfactant, and preferably to 15%, or to 10%, or to 7%, or to 5%, or to 4%, or to 3% nonionic surfactant. Alternatively, the detergent composition preferably comprises (by weight) from 7%, or preferably from 10%, or preferably from 15%, and preferably to 40%, or preferably to 30%, or preferably to 25%, or preferably to 20% nonionic surfactant. The detergent composition preferably comprises (by weight) from 1%, or preferably from 2%, or from 3% cationic surfactant, and preferably to 15%, or to 10%, or to 7%, or to 5%, or to 4%, or to 3% cationic surfactant. The detergent composition preferably comprises (by weight) from 1%, or preferably from 2%, or from 3%, or from 5%, or from 7%, or from 10% anionic surfactant, and preferably to 30%, or to 25%, or to 20%, or to 15% anionic surfactant.

### Building Agent

The detergent composition suitable for use herein may comprises a building agent. Said building agent may be water-soluble.

Typical water-soluble building agents include water soluble monomeric polycarboxylates, or their acid forms, homo or copolymeric polycarboxylic acids or their salts in which the polycarboxylic acid comprises at least two carboxylic radicals separated from each other by not more that two carbon atoms, borates, phosphates, and mixtures of any of the foregoing.

The carboxylate or polycarboxylate building agent can be monomeric or oligomeric in type although monomeric polycarboxylates are generally preferred for reasons of cost and performance. Suitable carboxylates containing one carboxy group include the water soluble salts of lactic acid, glycolic acid and ether derivatives thereof.

Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivatives such as the carboxymethyloxysuccinates described in British Patent No. 1,379,241, lactoxysuccinates described in British Patent No. 1,389,732, and aminosuccinates described in Netherlands Application 7205873, and the oxypolycarboxylate materials such as 2-oxa-1,1,3-propane tricarboxylates described in British Patent No. 1,387,447.

Polycarboxylates containing four carboxy groups include oxydisuccinates disclosed in British Patent No. 1,261,829, 1,1,2,2-ethane tetracarboxylates, 1,1,3,3-propane tetracarboxylates and 1,1,2,3-propane tetracarboxylates. Polycarboxylates containing sulfo substituents include the sulfosuccinate derivatives disclosed in British Patent Nos. 1,398,421 and 1,398,422 and in U.S. Pat. No. 3,936,448, and the sulphonated pyrolysed citrates described in British Patent No. 1,439,000. Preferred polycarboxylates are hydroxycarboxylates containing up to three carboxy groups per molecule, more particularly citrates.

Said water-soluble building agent may be an alkali or earth alkali metal salt of phosphate. Suitable examples of water-soluble phosphate building agents are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerisation ranges from about 6 to 21, and salts of phytic acid.

Alternatively, said building agent may be water-insoluble.

Preferred water insoluble builders include the aluminosilicates, especially sodium aluminosilicates. Suitable aluminosilicate zeolites have the unit cell formula Na_{z}[(AlO₂)_{z}(SiO₂)y]. xH₂O wherein z and y are at least 6; the molar ratio of z to y is from 1.0 to 0.5 and x is at least 5, preferably from 7.5 to 276, more preferably from 10 to 264. The aluminosilicate material are in hydrated form and are preferably crystalline, containing from 10% to 28%, more preferably from 18% to 22% water in bound form. The aluminosilicate zeolites can be naturally occurring materials, but are preferably synthetically derived. Synthetic crystalline aluminosilicate ion exchange materials are available under the designations Zeolite A, Zeolite B, Zeolite P, Zeolite X, Zeolite HS and mixtures thereof. Zeolite A has the formula:

Na 12 [AlO₂)12(SiO₂)₁₂]. xH₂O

wherein x is from 20 to 30, especially 27. Zeolite X has the formula Na₈₆ [(AlO₂)₈₆(SiO₂)₁₀₆]. 276 H₂O.

Preferred crystalline layered silicates for use herein have the general formula:

NaMSiₓO₂ₓ₊₁.yH₂O.

wherein M is sodium or hydrogen, x is a number from 1.9 to 4 and y is a number from 0 to 20. Crystalline layered sodium silicates of this type are disclosed in EP-A-0164514 and methods for their preparation are disclosed in DE-A-3417649 and DE-A-3742043. Herein, x in the general formula above preferably has a value of 2, 3 or 4 and is preferably 2. The most preferred material is δ-Na₂Si₂0₅, available from Hoechst AG as NaSKS-6.

The detergent composition herein preferably comprises (by weight) from 1%, preferably from 5%, or from 7%, or from 10%, or from 12%, or from 15% building agent, and preferably to 50%, or to 40%, or to 30%, or to 25% building agent.

### Bleaching Agent

Preferably, the composition for use herein comprises bleaching agent. Preferably said bleaching agent comprises perhydrate bleach, such as salts of percarbonates, particularly the sodium salts. It has been found that when the alkaline-soluble material of the bag herein comprises free hydroxy groups, such as Polyvinyl alcohol, the preferred bleaching agent comprises a percarbonate salt and is preferably free form any perborate salts and borate salts. Said borates and perborates interact with these hydroxy-containing materials and can reduce the dissolution of the materials and may also result in reduced performance. Thus, said detergent composition for use herein is preferably free of borate ions.

Preferred bleaching agents may comprise organic peroxyacid bleach precursor or activator compound, such as alkyl percarboxylic precursor compounds of the imide type include the N-,N,N¹N¹ tetra acetylated alkylene diamines wherein the alkylene group contains from 1 to 6 carbon atoms, particularly those compounds in which the alkylene group contains 1, 2 and 6 carbon atoms such as tetraacetyl ethylene diamine (TAED), sodium 3,5,5-tri-methyl hexanoyloxybenzene sulfonate (iso-NOBS), sodium nonanoyloxybenzene sulfonate (NOBS), sodium acetoxybenzene sulfonate (ABS) and pentaacetyl glucose, but also amide substituted alkyl peroxyacid precursor compounds.

### Enzyme

A highly preferred ingredient for use herein are one or more enzymes. Preferred enzymes include the commercially available lipases, cutinases, amylases, neutral and alkaline proteases, cellulases, endolases, esterases, pectinases, lactases and peroxidases conventionally incorporated into detergent compositions. Suitable enzymes are discussed in U.S. Pat. Nos. 3,519,570 and 3,533,139.

Preferred commercially available protease enzymes include those sold under the tradenames Alcalase, Savinase, Primase, Durazym, and Esperase by Novo Industries A/S (Denmark), those sold under the tradename Maxatase, Maxacal and Maxapem by Gist-Brocades, those sold by Genencor International, and those sold under the tradename Opticlean and Optimase by Solvay Enzymes. Preferred amylases include, for example, α-amylases obtained from a special strain of B licheniformis, described in more detail in GB-1,269,839 (Novo). Preferred commercially available amylases include for example, those sold under the tradename Rapidase by Gist-Brocades, and those sold under the tradename Termamyl, Duramyl and BAN by Novo Industries A/S. Highly preferred amylase enzymes maybe those described in PCT/ U.S. Pat. No. 9,703,635, and in W095/26397 and W096/23873. The lipase may be fungal or bacterial in origin being obtained, for example, from a lipase producing strain of Humicola sp., Thermomyces sp. or Pseudomonas sp. including Pseudomonas pseudoalcaligenes or Pseudomas fluorescens.

Lipase from chemically or genetically modified mutants of these strains are also useful herein. A preferred lipase is derived from Pseudomonas pseudoalcaligenes, which is described in Granted European Patent, EP-B-0218272.

Another preferred lipase herein is obtained by cloning the gene from Humicola lanuginosa and expressing the gene in Aspergillus oryza, as host, as described in European Patent Application, EP-A-0258 068, which is commercially available from Novo Industri A/S, Bagsvaerd, Denmark, under the trade name Lipolase. This lipase is also described in U.S. Pat. No. 4,810,414, Huge-Jensen et al, issued March 7, 1989.

### Method of Use

Soiled laundry is deposited in the bag herein, and said bag is preferably closed. Said bag is then preferably placed in the drum of an automatic washing machine. The detergent composition of the bag herein may comprise fabric softening agents, although preferably a separate fabric softening composition is added to the appropriate dispensing means of said automatic washing machine.

Said automatic washing machine typically undergoes one washing cycle, during which the alkaline-soluble material of said laundry bag, more preferably the bag herein as a whole, dissolves during said washing cycle, such that no residues are left on the laundry after the washing process, and in such a manner so that the soiled laundry to be washed is released into the wash liquor during the washing cycle.

After the washing cycle is completed, the washed laundry is removed from the automatic washing machine and allowed to dry by any laundry drying means known in the art, for example by using a tumble drier or a washing line.

Alternatively, the bag herein can be used in a hand-wash process, or any other laundry washing process known in the art. Preferably, the bag herein is used in an automatic washing machine process.

### EXAMPLES

Abbreviations used in the examples:

| Abbreviation | Description |
|---|---|
| PVA: | Polymer or co-polymer comprising polyvinyl alcohol |
| Alkoxylated | Tallow alcohol ethylene oxide condensate of type |
| alcohol: | tallow alcohol, condensed with an average of from 50 |
| | to 100 moles of ethylene oxide |
| Zeolite MCM41: | Ultra wide pore Zeolite-derivative MCM41, a M41S |
| | compound, described in more detail in U.S. Pat. No. |
| | 55378440 |
| CxyAS: | Sodium C₁ₓ-C_{1y} alkyl sulphate |
| CxyEz: | C₁ₓ-C_{1y}, predominantly linear primary |
| | alcohol condensed with an average of z moles of |
| | ethylene oxide |
| CxyEzS: | Sodium C₁ₓ-C_{1y}, alkyl sulfate condensed with z |
| | moles of ethylene oxide |
| FAS: | Fatty alkyl sulfate |
| LAS: | Sodium linear C₁₁-C₁₃ alkyl benzene sulfonate |
| Carbonate: | Anhydrous sodium carbonate |
| Silicate: | Amorphous sodium silicate (SiO₂:Na₂O = from 2:1 |
| | to 4:1) |
| Sulfate: | Anhydrous sodium sulfate |
| Citric acid: | Anhydrous citric acid |
| NaSKS-6: | Crystalline layered silicate of formula d-Na₂Si₂O₅ |
| Zeolite A: | Hydrated sodium aluminosilicate of formula |
| | Na₁₂(AlO₂SiO₂)₁₂.27H2O having a primary |
| | particle size in the range of from 0.1 to 10 micrometers |
| | (weight expressed on an anhydrous basis) |
| EDDS: | Ethylenediamine-N′N′-disuccinic acid, (S,S) isomer in |
| | the form of a sodium salt |
| HEDP: | 1,1 -hydroxyethane diphosphonic acid |
| Mg sulfate: | Anhydrous magnesium sulfate |
| Percarbonate: | Sodium percarbonate of the nominal formula |
| | 2Na₂CO₃.3H₂O₂ |
| NAC-OBS: | (6-nonamidocaproyl) oxybenzene sulfonate |
| NOBS: | Nonanoyloxybenzene sulfonate |
| TAED: | Tetraacetylethylenediamine |
| Photobleach(1): | Sulfonated zinc phthalocyanine |
| Photobleach(2): | Sulfonated alumino phthalocyanine |
| Brightener(1): | Disodium 4,4′-bis-(2-sulfostyryl)biphenyl, supplied by |
| | Ciba-Geigy under the tradename Tinopal CBS |
| Brightener(2): | Disodium 4,4′-bis-((4-anilino-6-morpholino-s-triazin- |
| | 2-yl)-amino}-2,2′-stilbenedisulfonate |
| CMC: | Sodium carboxymethyl cellulose |
| MA/AA(1): | Copolymer of maleic/acrylic acid, having a weight |
| | average molecular weight of from 50000 to 90000, |
| | wherein the ratio of maleic to acrylic acid is from |
| | 1:3 to 1:4 |
| QEA(1): | bis((C₂H₅0)(C₂H₄O)n)(CH₃)—N+—CₓH₂ₓ—N+— |
| | (CH₃)-bis((C₂H₅O)(C₂H₄0)n), wherein n = from |
| | 20 to 30, and x = from 3 to 8 |
| QEA(2): | sulphonated or sulphated |
| | bis((C₂H₅0)(C₂H₄O)n)(CH₃)—N+—CₓH₂ₓ— |
| | N+—(CH₃)-bis((C₂H₅O)(C₂H₄0)n), wherein n = |
| | from 20 to 30, and x = from 3 to 8 |
| SRP(1): | Anionically end capped polyesters |
| SRP(2): | Copolymer of dimethylterephthalate/propylene |
| | glycol/methyl capped polyethyl glycol |
| Silicone antifoam: | Polydimethyl siloxane foam controller with |
| | siloxane-oxyalkylene copolymer as dispersing agent, |
| | wherein the ratio of said foam controller to said |
| | dispersing agent is from 10:1 to 100:1 |
| Enzymes: | Amylase, Lipase, Protease, Cellulase and mixtures |
| | thereof |
| Soap: | Sodium linear alkyl carboxylate which is derived from |
| | a mixture of tallow and coconut fatty acids, wherein |
| | the ratio of tallow to coco fatty acids is from 70:30 |
| | to 99:1 |
| Perfume particle: | Perfume particle comprising a perfume and a carrier |
| | molecule |
| Encap Perfume: | Encapsulated perfume |

### Example 1

A first piece of PVA material, LXP film supplied by Chris Craft, is cut to a rectangle of the dimensions 85 cm by 58 cm. A second piece of PVA material, non-woven material K2 40 gsm material supplied by Cast Film Technology, is also cut to a rectangle of the dimensions 85 cm by 58 cm. A third piece of PVA material, non-woven material K2 40 gsm material supplied by Cast Film Technology, is to a rectangle of the dimensions 85 cm by 3 cm. The first piece of PVA material is placed parallel and on top of the second piece of PVA material, so that they are exactly aligned. The edge of one of the 85 cm sides are folded over to the outside and heat sealed along it's length using a Hulme Martin Heat Sealer, leaving a tubular hole, though which the third piece of PVA material is threaded. The tubular hole is of a size to just allow the third piece of PVA material to be threaded through. The first and second piece of PVA material are folded in half widthways across the 55 cm side, and heat sealed along the 55 cm side, sealing the third piece of PVA material in the tubular hole. The bottom of the bag, the side opposite to the side which is edged by the tubular hole, is heated sealed using a Hulme Martin Heat Sealer. Two small holes are cut in opposite sides at the top of the bag, in a position such to allow the ends of the third piece of PVA material to be exposed from the tubular structure. The third piece of PVA material can act as a drawstring and by pulling the ends of the drawstring will close the opening of the bag which has been formed. 100 g of detergent compositions, the formulations of which are described in more detail in example 2, are placed in one comer of the bag, respectively. Said detergent composition is sealed in place by making seals both to the top and the side around the detergent composition, to obtain a bag in accord with the present invention.

### Example 2

The following detergent compositions are added to a bag obtained by the process described in examples 1 and 3, respectively, to obtain a bag in accord with the present invention:

| Ingredient | A | B | C | D | E | F | G | H |
|---|---|---|---|---|---|---|---|---|
| Alkoxylated | 1 | 1 | 5 | 2 | 3 | 0.08 | 8 | 1 |
| alcohol | | | | | | | | |
| ZeoLite | 1 | 2 | 0.5 | 6 | 8 | 2 | 8 | 4 |
| MCM41 | | | | | | | | |
| C28AS | 0.5 | 0.6 | 1 | 0.2 | | | | |
| C28E3 | | | | | | | | |
| C28E5 | 3 | 5 | 7 | 2 | 4 | 6.5 | 5 | 3 |
| C25E3S | 1 | 0.5 | 0.8 | 1.2 | | | | |
| FAS | 2 | 0.5 | 0.2 | 1.5 | 0.2 | 0.8 | 1 | 0.6 |
| LAS | 5 | 6 | 6.5 | 5 | 7 | 5.5 | 6 | 5.5 |
| Carbonate | 16 | 15 | 20 | 18 | 25 | 27 | 15 | 22 |
| Silicate | 0.05 | 0.1 | 0.08 | 0.2 | 0.05 | 0.1 | 0.2 | 0.15 |
| Sulfate | 28 | 15 | 7 | 20 | 10 | 12 | 27 | 31 |
| Citric Acid | 2.5 | 2 | 4 | 1.5 | 5 | 3 | 3.5 | 4 |
| NaSKS-6 | 2 | 4 | 3.5 | 5 | 2.5 | 3 | 4 | 4.5 |
| Zeolite A | 15 | 20 | 17.5 | 15 | 18 | 16 | 14 | 15 |
| EDDS | 0.1 | 0.5 | 0.05 | 0.15 | 0.25 | 0.2 | 0.1 | 0.15 |
| HEDP | 0.1 | 0.05 | 0.2 | 0.15 | 0.1 | 0.1 | 0.3 | 0.2 |
| Mg Sulfate | 0.5 | 0.4 | 0.3 | 0.3 | 0.4 | 0.2 | 0.5 | 0.25 |
| Percarbonate | 12 | 15 | 18 | 10 | 8 | 12 | | |
| NAC_OBS | | | | | | | 2 | |
| NOBS | | | | | | | | 2 |
| TAED | 2.5 | 2 | 1.5 | 3 | 1 | 5 | | |
| Photobleach(1) | 0.00 | 0.00 | | | 0.00 | | | |
| | 1 | 5 | | | 2 | | | |
| Photobleach(2) | | | 0.00 | 0.001 | 0.00 | | | |
| | | | 5 | | 2 | | | |
| Brightener(1) | 0.02 | 0.1 | 0.08 | 0.05 | 0.1 | | | |
| Brightener(2) | 0.02 | | | 0.05 | | 0.05 | 0.1 | 0.06 |
| CMC | 0.15 | 0.1 | 0.2 | 0.5 | 0.05 | 0.1 | 0.25 | 0.1 |
| MA/AA(1) | 1.5 | 2.5 | 2 | 2.5 | 1 | 3 | 0.5 | 1.0 |
| QEA(1) | 0.5 | | 0.3 | 1.2 | 1.0 | | 0.4 | 1.0 |
| QEA(2) | | 0.8 | | | | 0.6 | | |
| SRP(1) | 0.1 | | | 0.08 | 0.15 | 0.2 | 0.05 | 0.03 |
| SRP(2) | | 0.15 | 0.1 | | | | | |
| Silicone | 0.05 | 0.1 | 0.02 | | 0.08 | 0.01 | 0.05 | 0.03 |
| antifoam | | | | | | | | |
| Enzymes | 1.0 | 0.8 | 0.6 | 1.2 | 0.5 | | | 0.4 |
| Soap | 0.6 | 0.5 | 0.1 | 0.05 | 0.3 | 0.4 | 0.5 | 0.5 |
| Perfume | 0.3 | 0.4 | 0.25 | 0.5 | 0.4 | 0.6 | 0.3 | 0.2 |
| particle | | | | | | | | |
| Encap perfume | | | | | 0.1 | 0.2 | | |
| Miscellaneous | to | to | to | to | to | to | to | to |
| | 100% | 100% | 100% | 100% | 100% | 100% | 100% | 100% |

### Example 3

2 pieces of PVA material, LXP 4087 film supplied by Chris Craft, are cut to a rectangle of dimensions 60 cm by 30 cm. One piece of PVA material is placed in parallel exactly on top of the other piece of PVA material. The two pieces of PVA material are heat sealed together along both long 60 cm edges and one 30 cm edge using a Martin Hulme Heat Sealer, to form a bag. A third piece of PVA material, LXP 4087 film supplied by Chris Craft, is cut to a rectangle of dimensions 70 cm by 3 cm. The third piece of PVA material is heat sealed to the unsealed open 30 cm side of the bag. This third piece of PVA material can act as a tier to close the bag. 100 g of solid detergent composition, the formulations of which are described in more detail in example 2, is placed inside the bag to obtain a bag in accord with the present invention.

### Example 4

A first piece of PVA material, non-woven polyvinyl alcohol K2 40 gsm material supplied by Cast Film Technology, is cut to a rectangle of dimensions 52 cm by 50 cm. A second piece of PVA material, non-woven polyvinyl alcohol K2 40 gsm material supplied by Cast Film Technology, is cut to a rectangle of dimensions 50 cm by 3 cm. The second piece of PVA material is placed on top along one of the 50 cm edges of the first piece of PVA material. Said 50 cm edge of the first piece of PVA material is folded over the second piece of PVA material to form a fold, which contains the second piece of PVA material. The first piece of PVA material is heat sealed to itself along the length of the fold so that a tubular structure containing the second piece of PVA material is formed. The first piece of PVA material is folded in half along the 52 cm side and the open 52 cm edge is sealed using a Martin Hulme Heat Sealer. The edge opposite to the edge containing the tubular structure is sealed using a Martin Hulme Heat Sealer, to form a bag. Two holes are cut in opposite sides of the bag so that the ends of the second piece of PVA material are exposed from the tubular structure. The second piece of PVA material can act as a drawstring, and the bag can be closed by pulling the ends of the drawstring. 50 g of solid detergent composition, the formulations of which are described in more detail in example 2, is placed in one comer of the bag, respectively. Said detergent composition is sealed in place by making seals both to the top and the side around the detergent composition, to obtain a bag in accord with the present invention.

### Example5

75 g of solid detergent, the formulations of which are described in more detail in example 2, is sealed in a pouch made of a PVA material, K2 40 gsm supplied by Cast Film Technology. The pouch was made by cutting two pieces of PVA material, K2 40 gsm supplied by Cast Film Technology, to rectangles of dimensions 20 cm by 16 cm. One piece of PVA material was placed parallel on top of the other piece of PVA material and the pieces of PVA material are sealed together on three sides using a Martin Hulme Heat Sealer, to form a pouch. 75 g detergent composition is placed inside the pouch, the pouch is then closed by heat sealing the unsealed side. The pouch is sealed onto the bottom of a bag made according to the process described in examples 1, 3 and 4.

### Example 6

A sheet of PVA material (Chris-Craft LXP 4087 film) is placed over a cylindrical-shaped mold having round sides and bottom and a diameter of 45 mm and a depth of 28 mm. A 1 mm thick layer of rubber is present around the edges of the mold. The mold has some holes in the mold material to allow a vacuum to be applied.

A vacuum is applied to pull the film into the mold so that the PVA material is flush with the inner surface of the mold. 20 g of solid detergent composition is poured into the mold so that the mold is filled between 95% to 100%.

Next, another sheet of PVA material (Chris-Craft LXP 4087 film) is placed over the top of the mold with the solid composition, and is sealed to the first layer of film by applying an annular piece of flat metal of an inner diameter of 46 mm and heating that metal under moderate pressure onto the ring of rubber at the edge of the mold to heat-seal the two pieces of PVA material together. The metal ring is typically heated to a temperature of 140-146° C. and applied for up to 5 seconds. One or more pouches are added to the bag as made in example 1, 3, 4, respectively.

### Example 7

A bag is made by the process described in example 1, 3 and 4, respectively. 75 g of solid detergent composition, the formulation of which is described in more detail in example 2, is placed in one corner of the bag. Said detergent composition is sealed in place by making seals both to the top and the side around the detergent composition, to obtain a bag in accord with the present invention.

What is claimed is:

1. A laundry bag made of an alkaline-soluble material, said laundry bag comprising a detergent composition.

2. A laundry bag according to claim 1, wherein said alkaline-soluble material is selected from the group consisting of a non-woven material, a film, a laminate of a film, a non-woven material, and combinations thereof.

3. A laundry bag according to claim 1, wherein said alkaline-soluble material comprises polyvinyl alcohol polymer or a co-polymer of a polyvinyl alcohol.

4. A laundry bag according to claim 1, wherein said alkaline-soluble material is substantially alkaline-soluble at 40° C., and substantially water-insoluble at 20° C.

5. A laundry bag according to claim 1, wherein said alkaline-soluble material comprises plasticizer, preferably at a level of 10% by weight of said alkaline-soluble material.

6. A laundry bag according to claim 5, wherein said alkaline-soluble material is at a level of 10%, by weight.

7. A laundry bag according to claim 1, wherein at least a portion of said detergent composition is contained within a pouch of alkaline-soluble material, and said pouch is contained within said laundry bag.

8. A laundry bag according to claim 1, wherein said detergent composition comprises at least 5% by weight of surfactant and/or at least 5% by weight of building agent, and optionally comprises bleaching agent and/or enzyme.

9. A laundry bag according to claim 1, wherein said detergent composition comprises an alkoxylated compound having an average alkoxylation degree of at least 25.

10. A laundry bag according to claim 1, wherein said detergent composition comprises effervescence system, said effervescence system comprising an acid source and an alkali source which can react together to produce a gas when contacted to water.

11. A laundry bag according to claim 1, wherein said detergent composition comprises an odour controlling agent.

12. A laundry bag according to claim 11, wherein said odour controlling agent is at a level of at least 10%, by weight.

13. A laundry bag according to claim 11, wherein said detergent composition is contained in said laundry bag in at least two parts, wherein a first part of said detergent composition is contained separately in said laundry bag from one or more other parts of said detergent composition, and wherein said first part of said detergent composition comprises at least 60%, by weight of said first part, of odour controlling agent.

14. A process for preparing a laundry bag according to claim 7, said process comprises the steps of adding a detergent composition, or part thereof, to a pouch of alkaline-soluble material, and adding said pouch to a laundry bag made of alkaline-soluble material.
